(19) United States
(12) Patent Application Publication
(10) Pub. No.: US 2011/0283178 A1
(43) Pub. Date: Nov. 17, 2011

(54) FACILITATING ELECTRONIC COLLECTION AND MAINTENANCE OF PREFLIGHT DOCUMENTATION IN HELICOPTER AIR AMBULANCE INDUSTRY

(76) Inventor: Grant HOOK, London (GB)

(21) Appl. No.: 13/110,982

(22) Filed: May 19, 2011

Related U.S. Application Data
(63) Continuation of application No. 12/960,324, filed on Dec. 3, 2010.
(60) Provisional application No. 61/266,496, filed on Dec. 3, 2009.

(51) Int. Cl. G06F 17/00; G06F 15/16

(52) U.S. Cl. 715/224

(57) ABSTRACT

A method for facilitating remote storage of preflight documentation for a helicopter air ambulance includes filling out a preflight documentation form for a helicopter air ambulance with a specially configured pen, the preflight documentation form including tiny dots printed thereon, and the specially configured pen being configured to electronically record information associated with marks made on the preflight documentation form; electronically communicating the information associated with marks made on the preflight documentation form, together with an identification of the specially configured pen, to a remote server; and generating, at the remote server, an electronic copy of the preflight documentation form including markings or text representative of the marks made on the preflight documentation form. The steps of filling out a preflight documentation form and electronically communicating information occur prior to takeoff of the helicopter air ambulance.

### CROSS-REFERENCE TO RELATED APPLICATION

The present application is a U.S. continuation patent application of, and claims priority under 35 U.S.C. §120 to, U.S. nonprovisional patent application Ser. No. 12/960,324, filed Dec. 3, 2010, which nonprovisional patent application is hereby incorporated herein by reference, and which nonprovisional patent application is a U.S. nonprovisional patent application of, and claims priority under 35 U.S.C. §119(e) to, U.S. provisional patent application Ser. No. 61/266,496, filed Dec. 3, 2009, which is incorporated herein by reference. A copy of the nonprovisional patent application is attached as an appendix hereto and incorporated herein by reference.

The present application hereby incorporates herein by reference, for at least the purposes of disclosing additions, enhancements, modifications, and improvements thereto,

(a) the disclosures of the following U.S. Patent Application Publications:

| | | |
|---|---|---|
| US20020118181, | US20020158848, | US20030061188, |
| US20020166895, | US20020056085, | US20020004699, |
| US20010038383, | US20020006214, | US20020048404, |
| US20020050982, | US20020054778, | US20020026425, |
| US20020059140, | US20020138568, | US20020135805, |
| US20020198847, | US20020152094, | US20020159089, |
| US20020163511, | US20020190966, | US20030014327, |
| US20030046184, | US20030138144, | US20030158888, |
| US20030123745, | US20040155115, | US20050177534, |
| US20050200610, | US20070097099, | US20070043685, |
| US20070114367, | US20070115152, | US20080219736, |
| US20070064818, | US20070272750, | US20070299896, |
| US20080075396, | US20070246539, | US20080296074, |
| US20090019292, | US20080094377, | US20080088607, |
| US20080129711, | US20080089586, | US20080235282, |
| US20090078475, | US20090127006, | US20090021493, |
| US20090021494, | US20090063492, | US20090000832, |
| US20090027400, | US20090021495, | US20090024988, |
| US20090022332, | US20090022343, | US20090052778, |
| US20090019360, | US20090002345, | US20090002346, |
| US20090204821; | | |

(b) and the disclosures of the following U.S. Patents:

| | | | | | |
|---|---|---|---|---|---|
| 5,852,434, | 6,299,151, | 6,502,756, | 6,529,920, | 6,548,768, | 6,570,104, |
| 6,586,688, | 6,663,008, | 6,666,376, | 6,667,695, | 6,674,427, | 6,689,966, |
| 6,698,660, | 6,719,470, | 6,722,574, | 6,732,927, | 6,836,555, | 6,854,821, |
| 6,864,880, | 6,878,062, | 6,927,916, | 6,929,183, | 6,947,033, | 6,958,747, |
| 6,966,495, | 6,992,655, | 7,002,559, | 7,035,429, | 7,050,653, | 7,054,487, |
| 7,072,529, | 7,094,977, | 7,110,604, | 7,120,320, | 7,121,465, | 7,127,682, |
| 7,143,952, | 7,145,556, | 7,154,056, | 7,162,087, | 7,167,164, | 7,175,095, |
| 7,176,896, | 7,180,509, | 7,202,861, | 7,202,963, | 7,239,306, | 7,254,839, |
| 7,278,017, | 7,283,676, | 7,293,697, | 7,295,193, | 7,296,075, | 7,315,938, |
| 7,319,459, | 7,321,692, | 7,333,947, | 7,353,393, | 7,356,012, | 7,382,361, |
| 7,385,595, | 7,415,501, | 7,418,160, | 7,441,183, | 7,457,413, | 7,457,476, |
| and | 7,600,693. | | | | |

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention primarily relates to the facilitation of the collection and maintenance of preflight documentation in the helicopter air ambulance industry and, in particular, to the capture, transmission, confirmation, and retention of preflight documentation by emergency medical services operators in the helicopter air ambulance industry.

As of February 2009, there were seventy-four (74) helicopter air ambulance operators authorized by the Federal Aviation Administration (FAA) to conduct helicopter air ambulance operations. These helicopter air ambulance operators operate approximately eight hundred and fifty (850) helicopters in air ambulance operations. The size of these operations varies greatly; of the seventy-four helicopter air ambulance operators, thirty-eight (38) certificate holders have five (5) or fewer helicopters; fourteen (14) helicopter air ambulance operators have six (6) to ten (10) helicopters each; six (6) helicopter air ambulance operators have eleven (11) to fifteen (15) helicopters each; and sixteen (16) helicopter air ambulance operators have more than sixteen (16) helicopters each. The smallest operators only have one or two helicopters and operate in one region; the largest operators may have hundreds of helicopters across the United States. Of the fifty largest certificate holders operating aircraft under parts 121 or 135 of the CFR, as measured by the number of aircraft operated, six conduct helicopter air ambulance operations, with the tenth largest air carrier in the United States being Air Methods Corporation, a helicopter air ambulance operator.

From 1992 through 2009, there were one hundred and thirty-five (135) helicopter air ambulance accidents, including one midair collision with another helicopter engaged in an air ambulance operation. These helicopter air ambulance accidents resulted in one hundred and twenty-six (126) fatalities. In a 2009 report, the U.S. Government Accountability Office recognized that air ambulance accidents reached historic levels from 2003 through 2008.

In part based on this, the FAA recently published proposed rules in the Federal Register on Oct. 12, 2010 setting forth requirements for air ambulance helicopter operations. The proposed rules aim to address safety concerns arising from this increase in fatalities. Under the proposed rules, all helicopter air ambulance operators are required to implement preflight risk-analysis programs and pilots are required to complete preflight risk analysis worksheets. A pilot in command of a helicopter air ambulance is required to conduct a preflight risk assessment and document on a risk analysis worksheet the preflight risk analysis. The pilot is directly responsible for accurately completing the risk analysis worksheet before takeoff and signing the completed risk analysis worksheet with the date and time of signing. The helicopter air ambulance operator must retain the original or a copy of the completed risk analysis worksheet at a location specified in its operations manual for at least ninety (90) days from the date of the flight. Unfortunately, the procedures for collecting and maintaining the risk analysis worksheets need to be outlined in the helicopter air ambulance operator's operations manual, but no specific specifications or guidelines are provided in the proposed rules by the FAA regarding specifically how the worksheets are collected and maintained.

Also under the proposed rules, helicopter air ambulance operators with ten (10) or more helicopters engaged in helicopter air ambulance operations are required to establish operations control centers staffed with operations control specialists. The operations control specialists are required to maintain two-way communications with pilots; provide pilots with weather information to include current and forecasted weather along the planned route of flight; monitor flight progress; and participate in preflight risk analysis. Moreover, with respect to the preflight risk analysis, the operations control specialist are required to ensure that the pilot completes the preflight risk analysis worksheet, are required to confirm and verify the entries on the worksheet, and are required to work with the pilot to mitigate any identified risk. The operations control specialist, along with the pilot in command, are required to acknowledge in writing (by signing, initialing, or another method as defined in the helicopter air ambulance operator's operations manual) that the worksheet has been completed accurately. It is generally thought that the operations control specialist's review of the risk assessment will provide an additional measure of safety to helicopter air ambulance flights. By signing the worksheet, the operations control specialist indicates that he or she agrees with the level of risk associated with the flight. Furthermore, failure to comply will subject the operations control specialist to enforcement action and civil penalties. Unfortunately, the procedures for collecting and maintaining the operations control specialist's signature need to be outlined in the helicopter air ambulance operator's operations manual, but no specific specifications or guidelines are provided in the proposed rules by the FAA regarding specifically how this is to be accomplished.

Additionally, under the proposed rules each helicopter air ambulance operator is responsible for a preflight preparation of a load manifest detailing information such as helicopter weight, center of gravity, crewmember identification, and other helicopter information. The load manifest is used in the event of an emergency to account for aircraft occupants and, in the case of a fatal or serious accident, contact next of kin. Additionally, in the event of an accident, the load manifest information pertaining to the helicopter's weight and balance is useful in determining whether the helicopter was loaded within the center-of-gravity limits and maximum allowable takeoff weight. The manifest must be prepared in duplicate unless the helicopter air ambulance operator receives prior to takeoff a copy of the load manifest, by electronic or other means, at its principal operations base or at another location used by it and approved by the FAA. The load manifest may be transmitted by facsimile, e-mail, online form, or other electronic means, but the information must be received by the helicopter air ambulance operator's base of operations or other approved location before takeoff. If the helicopter air ambulance operator does not receive a copy of the load manifest prior to takeoff, then the pilot in command of the helicopter must arrange at the takeoff location for a copy of the load manifest to be sent to the helicopter air ambulance operator, retained in a suitable place at the takeoff location, or retained in another location approved by the FAA until the flight is complete. In either case, the pilot in command of the helicopter must carry a copy of the completed load manifest in the helicopter to the destination of the flight. These steps ensure that the load manifest information is available in the event that the copy carried on board the helicopter is destroyed. The helicopter air ambulance operator must keep a copy of the completed load manifests for at least thirty (30) days at its principal operations base.

Unfortunately, while the load manifest need not be prepared in duplicate for certificate holders who elect to electronically transmit the information contained in the load manifest to their operations base before takeoff, no directions or guidelines are provided in the proposed rules by the FAA regarding how such communications are effected or how the pilot in command ensures that the load manifest has been successfully transmitted to the operations base before takeoff.

Helicopter air ambulance operations are often time-sensitive and crucial to getting a critically ill or injured patient to a medical facility as efficiently as possible. Consequently, it is believed that in view of the foregoing a need exists for facilitating the efficient and expeditious collecting and maintaining of preflight risk analysis worksheets, signatures of operations control specialists (when applicable), and load manifests so that delay in takeoff is avoided. This, and other needs, are addressed by one or more aspects or features of the present invention.

### SUMMARY OF THE INVENTION

The present invention includes many aspects and features. Moreover, while many aspects and features relate to, and are described in, the context of electronic preflight documentation in the helicopter air ambulance industry and, in particular, to the transmission, confirmation, and retention of preflight documentation by emergency medical services operators in such industry, the present invention is not limited to use only in this context, as will become apparent from the following summaries and detailed descriptions of aspects, features, and one or more embodiments of the present invention. Thus, for example, the present invention further may be used in the context of electronic preflight documentation for commercial helicopter operation.

One aspect of the present invention relates in particular to a method for facilitating remote storage of preflight documentation for a helicopter air ambulance. As used herein, “preflight documentation” means one or more electronic or written documents completed prior to flight such as, for example, a daily flight log (DFL), a load manifest, a risk analysis worksheet, or combination thereof whether comprised of a single form or multiple forms.

This particular method for facilitating remote storage of preflight documentation for a helicopter air ambulance includes filling out, by a pilot of the helicopter air ambulance, a preflight documentation form with a specially configured pen, the preflight documentation form including a plurality of tiny dots printed thereon, and the specially configured pen being configured to electronically record information associated with marks made by the pen on the preflight documentation form; transmitting information associated with marks made on the preflight documentation form, together with an identification of the specially configured pen, to an communication device configured for forwarding the information and identification to a remote server; receiving, at the communication device, the transmitted information associated with marks made on the preflight documentation form and identification of the specially configured pen; communicating, from the communication device to a remote server, the information associated with marks made on the preflight documentation form and identification of the specially configured pen received at the communication device; receiving, at the remote server, the communicated information associated with marks made on the preflight documentation form and identification of the specially configured pen; processing, at the remote server, the information associated with marks made on the preflight documentation form, said processing including generating an electronic copy of the preflight documentation form including markings or text representative of the marks made on the preflight documentation form; and communicating, from the remote server to a display device, the electronic copy of the preflight documentation form including markings or text representative of the marks made on the preflight documentation form. The step of receiving, at the remote server, the communicated information associated with marks made on the preflight documentation form and identification of the specially configured pen occurs prior to launching of the helicopter air ambulance.

In a feature of this aspect, the method further comprises the step of providing an acknowledgment, to the pilot, that an electronic copy of the preflight documentation form has been generated.

In a feature of this aspect, the method further comprises the step of providing an acknowledgment, to the pilot, that an electronic copy of the preflight documentation form is being stored remotely.

In a feature of this aspect, the method further comprises the steps of providing an electronic copy of the preflight documentation form to a operations control specialist, and verbally confirming, by the operations control specialist via two way radio communications, receipt of an electronic copy of the preflight documentation form. In at least some preferred implementations, the operations control specialist orally reads back at least some portion of information contained in the electronic copy of the preflight documentation form to the pilot for confirmation.

In a feature of this aspect, the communication device comprises a mobile device.

In a feature of this aspect, the communication device comprises a smartphone.

In a feature of this aspect, the step of communicating, from the communication device to a remote server, the information associated with marks made on the preflight documentation form and identification of the specially configured pen received at the communication device comprises communicating via email.

In a feature of this aspect, the step of communicating, from the communication device to a remote server, the information associated with marks made on the preflight documentation form and identification of the specially configured pen received at the communication device comprises communicating via satellite.

In a feature of this aspect, the step of communicating, from the communication device to a remote server, the information associated with marks made on the preflight documentation form and identification of the specially configured pen received at the communication device comprises communicating via GSM.

In a feature of this aspect, the step of transmitting information associated with marks made on the preflight documentation form, together with an identification of the specially configured pen, to an communication device configured for forwarding the information and identification to a remote server comprises transmitting via a Bluetooth connection.

In a feature of this aspect, the communication device is disposed inside of, attached to, or is part of the helicopter air ambulance.

In a feature of this aspect, the communication device and the display device are the same device.

In a feature of this aspect, the display device is a computer used by an operations control specialist.

In a feature of this aspect, the step of processing, at the remote server, the information associated with marks made on the preflight documentation form includes determining an entity associated with the preflight documentation form based on a pattern of the plurality of tiny dots of the preflight documentation form.

Another aspect of the present invention relates to a system for facilitating the remote storage of preflight documentation. The system includes a plurality of preflight documentation forms, each of the preflight documentation forms including a plurality of tiny dots printed thereon, wherein at least some of the preflight documentation forms have a different pattern of tiny dots printed thereon than at least some of the other preflight documentation forms; a plurality of specially configured pens, each specially configured pen being configured to electronically record information associated with marks made on at least one of the preflight documentation forms and to electronically communicate such information to one or more remote servers, wherein each specially configured pen includes an identification electronically stored therein; and one or more remote servers configured to receive information associated with marks made on at least one of the preflight documentation forms from one or more of the specially configured pens and process such information and generate an electronic copy of any preflight documentation form for which information associated with marks made on that preflight documentation form was received.

In a feature of this aspect, the remote server is further configured to communicate a generated electronic copy of a preflight documentation form to an email address associated with the pattern of tiny dots printed on that preflight documentation form.

In a feature of this aspect, the remote server is further configured to communicate a generated electronic copy of a preflight documentation form to an email address associated with the unique identification of the specially configured pen used to fill out that preflight documentation form.

In a feature of this aspect, the system further includes a plurality of communication devices, each communication device being configured to receive information wirelessly from one of the specially configured pens and communicate such received information to one or more of the one or more remote servers.

Another aspect of the present invention relates to a method. The method includes filling out a preflight documentation form for a helicopter air ambulance flight with a specially configured pen, the preflight documentation form including a pattern of tiny dots printed thereon, and the specially configured pen being configured to electronically record information associated with marks made by the pen on the preflight documentation form; electronically communicating the information associated with marks made on the preflight documentation form, together with an identification of the specially configured pen, from the pen to a remote server; and processing, at the remote server, the received information associated with marks made on the preflight documentation form, said processing including generating an electronic copy of the preflight documentation form including markings or text representative of the marks made on the preflight documentation form. The steps of filling out a preflight documentation form and electronically communicating information occur prior to launching of the helicopter air ambulance on the helicopter air ambulance flight.

Another aspect of the present invention relates to a method for facilitating remote storage of preflight documentation for an aircraft. The method includes (a) completing, by a pilot of the aircraft, a preflight documentation form with a digital pen, the preflight documentation form including a plurality of tiny dots printed thereon, and the digital pen being configured to electronically record information associated with marks made on the preflight documentation form; (b) transmitting information associated with marks made on the preflight documentation form to a communication device configured for forwarding the information to a remote server; (c) receiving, by the communication device, the transmitted information associated with marks made on the preflight documentation form; (d) communicating, from the communication device to the remote server, the information associated with marks made on the preflight documentation form and received by the communication device; (e) receiving, by the remote server, the communicated information associated with marks made on the preflight documentation form; (f) processing, at the remote server, the information associated with marks made on the preflight documentation form, said processing including generating an electronic copy of the preflight documentation form including markings or text representative of the marks made on the preflight documentation form; and (g) saving the generated electronic copy of the completed preflight documentation form in a computer database or file server for later access and display. Steps (a) through (g) occur before takeoff of the aircraft.

In a feature of this aspect, the aircraft is a single-engine aircraft.

In a feature of this aspect, the aircraft is a multi-engine aircraft.

In a feature of this aspect, the aircraft is a fixed-wing aircraft.

In a feature of this aspect, the aircraft is a helicopter.

In a feature of this aspect, the aircraft is an air ambulance.

In a feature of this aspect, the aircraft is a commercial services aircraft.

In a feature of this aspect, the method further includes the step of providing an acknowledgement to the pilot of the aircraft.

In a feature of this aspect, the method further includes the step of providing an acknowledgement to the pilot of the aircraft, and wherein the acknowledgement represents that steps (a) through (g) have been performed.

In a feature of this aspect, an identification of the digital pen is included with the information associated with marks made on the preflight documentation form.

In a feature of this aspect, an identification of the digital pen is saved in association with the generated electronic copy of the completed preflight documentation form.

In a feature of this aspect, the generated electronic copy of the completed preflight documentation form includes a handwritten signature of the pilot.

In a feature of this aspect, the method includes two-factor authentication of the pilot, namely, authentication by the serial number of the digital pen and the biometric handwritten signature of the pilot.

In a feature of this aspect, the step of processing, at the remote server, the information associated with marks made on the preflight documentation form includes determining an entity associated with the preflight documentation form based on a pattern of the plurality of tiny dots of the preflight documentation form, whereby the remote server is able to accommodate multiple aircraft operators.

In a feature of this aspect, the step of processing, at the remote server, the information associated with marks made on the preflight documentation form includes determining an entity associated with the preflight documentation form based on a pattern of the plurality of tiny dots of the preflight documentation form, whereby the remote server is able to accommodate multiple aircraft operators, and wherein the remote server is provided by a third party service provider who is not an aircraft operator.

In a feature of this aspect, the preflight documentation form comprises a daily flight log.

In a feature of this aspect, the preflight documentation form comprises a load manifest.

In a feature of this aspect, the preflight documentation form comprises a risk analysis worksheet.

In a feature of this aspect, the preflight documentation form comprises a combination of a daily flight log, a load manifest, and a risk analysis worksheet.

One or more aspects of the present invention relate to improvements, enhancements, modifications, and/or additions to one or more technologies, and/or implementations thereof, disclosed in one or more of the above described technologies or implementations, including the above noted patents and/or publications incorporated herein by reference.

Another aspect of the present invention relates to a method of displaying a form generated using interpreted data based on marks made by a specially configured pen upon digital paper.

Another aspect of the present invention relates to a method of designing a form.

Another aspect of the present invention relates to a method of designing a form such that it includes zones.

Another aspect of the present invention relates to a method of allowing a user to specify zones when designing a form.

Another aspect of the present invention relates to a method of designing a form which includes mapping fields.

Another aspect of the present invention relates to a method of allowing a user to design a form utilizing mapping fields.

Another aspect of the present invention relates to a method of posting a digital pen and paper enabled (“DPP-enabled”) form to a server.

Another aspect of the present invention relates to a method for server side printing of a form.

Another aspect of the present invention relates to a method for client side printing of a form.

Another aspect of the present invention relates to a method of relaying information from a pen to a server via a dock.

Another aspect of the present invention relates to a method of relaying information from a pen to a server via a wireless connection.

Another aspect of the present invention relates to a method of presenting to a user a review page.

Another aspect of the present invention relates to a method of interacting with a review page.

Another aspect of the present invention relates to a method of reviewing a form via a review page.

Another aspect of the present invention relates to a method of generating content based on information relayed from a digital pen.

Another aspect of the present invention relates to a method of generating content utilizing handwriting recognition.

Another aspect of the present invention relates to a method comprising storing a graphical representation of markings along with, and preferably in association with, generated content or data in one or more databases.

Another aspect of the present invention relates to a method for server interrogation comprising making a real-time call to a server or service to retrieve information.

Another aspect of the present invention relates to a method of processing a form.

Another aspect of the present invention relates to a method of processing a form comprising generating a message.

Another aspect of the present invention relates to a method for facilitating remote storage of preflight documentation for a helicopter air ambulance. The method includes transmitting, by a pen, data to a communication device configured for forwarding of the data to a remote server, the data comprising, information associated with marks made on a preflight documentation form with the pen, and an identification of the pen. The pen is configured to electronically record information associated with marks made with the pen on the preflight documentation form, and marks made on the preflight documentation form include a handwritten signature of a pilot. The method further includes receiving, at the communication device, the transmitted data comprising information associated with marks made with the pen on the preflight documentation form and the identification of the pen; communicating, from the communication device to a remote server, the data comprising information associated with marks made with the pen on the preflight documentation form and the identification of the pen received at the communication device; receiving, at the remote server, the communicated data comprising information associated with marks made with the pen on the preflight documentation form and the identification of the pen; and processing, at the remote server, the information associated with marks made with the pen on the preflight documentation form, said processing including generating an electronic copy of the preflight documentation form representative of the preflight documentation form, including the handwritten signature of the pilot. The step of receiving, at the remote server, the communicated data comprising information associated with marks made on the preflight documentation form and the identification of the pen occurs prior to launching of the helicopter air ambulance.

In a feature of this aspect, the method further comprises the step of providing an acknowledgment, to the pilot, that an electronic copy of the preflight documentation form has been generated and is being stored remotely.

In a feature of this aspect, the method further comprises the steps of providing an electronic copy of the preflight documentation form to an operations control specialist who is responsible for verbally confirming, via two way radio communications with the pilot, receipt of an electronic copy of the preflight documentation form.

In a feature of this aspect, the marks made on the preflight documentation form are ink marks and wherein the preflight documentation form is a paper form.

In at least some implementations, the communication device comprises a mobile consumer electronic device.

In a feature of this aspect, the step of communicating, from the communication device to a remote server, the data comprising information associated with marks made on the preflight documentation form and the identification of the pen received at the communication device comprises communicating via email.

In a feature of this aspect, the step of communicating, from the communication device to a remote server, the data comprising information associated with marks made on the preflight documentation form and identification of the pen received at the communication device comprises communicating via satellite.

In a feature of this aspect, the step of communicating, from the communication device to a remote server, the data comprising information associated with marks made on the preflight documentation form and identification of the pen received at the communication device comprises communicating via GSM.

In a feature of this aspect, the step of transmitting data comprising information associated with marks made on the preflight documentation form, and an identification of the pen, to a communication device configured for forwarding the data to a remote server comprises transmitting via a Bluetooth connection.

In a feature of this aspect, the communication device is disposed inside of, attached to, or is part of the helicopter air ambulance.

In a feature of this aspect, the preflight documentation form includes a plurality of tiny dots printed thereon, and wherein said step of processing, at the remote server, the information associated with marks made with the pen on the preflight documentation form includes determining an entity associated with the preflight documentation form based on a pattern of the plurality of tiny dots of the preflight documentation form.

Another aspect of the present invention relates to a method for facilitating remote storage of preflight documentation for a helicopter air ambulance. The method includes transmitting, by a pen, data to a communication device configured for forwarding of the data to a remote server, the data comprising, information associated with marks made on a preflight documentation form with the pen, and an identification of the pen. The pen is configured to electronically record information associated with marks made on the preflight documentation form. The method further includes receiving, at the communication device, the transmitted data comprising information associated with marks made on the preflight documentation form and the identification of the pen; communicating, from the communication device to a remote server, the data comprising information associated with marks made on the preflight documentation form and the identification of the pen received at the communication device; receiving, at the remote server, the communicated data comprising information associated with marks made on the preflight documentation form and the identification of the pen; processing, at the remote server, the information associated with marks made on the preflight documentation form, said processing including generating an electronic copy of the preflight documentation form including markings or text representative of marks made on the preflight documentation form; receiving, at an electronic device, a confirmation of receipt of the data comprising information associated with marks made on the preflight documentation form and the identification of the pen, the confirmation including an electronic copy of the preflight documentation form including markings or text representative of marks made on the preflight documentation form; and displaying, on a display of the electronic device, the electronic copy of the preflight documentation form including markings or text representative of marks made on the preflight documentation form. The step of displaying, on a display of the electronic device, the electronic copy of the preflight documentation form occurs prior to launching of the helicopter air ambulance.

In a feature of this aspect, the electronic device and the communication device are the same device.

In a feature of this aspect, the communication device comprises a mobile device.

In a feature of this aspect, the communication device is disposed inside of, attached to, or is part of the helicopter air ambulance.

In a feature of this aspect, the electronic device is disposed proximate an operations control specialist and is configured to display the electronic copy for viewing by the operations control specialist.

Another aspect of the present invention relates to a method for facilitating remote storage of preflight documentation for a helicopter air ambulance. The method includes filling out, by a pilot of the helicopter air ambulance, a preflight documentation form with a specially configured pen, the filling out including hand signing, with the specially configured pen, the preflight documentation form. The preflight documentation form includes a plurality of tiny dots printed thereon, and the specially configured pen is configured to electronically record information associated with marks made on the preflight documentation form. The method further includes effecting transmission, from the specially configured pen, of data to a communication device configured for forwarding of the data to a remote server. The data includes information associated with marks made on the preflight documentation form, and an identification of the specially configured pen. The preflight documentation form includes a plurality of tiny dots printed thereon, the specially configured pen is configured to electronically record information associated with marks made on the preflight documentation form, and marks made on the preflight documentation form include a handwritten signature of the pilot. The method still further includes receiving, by the pilot, a confirmation of remote storage of an electronic copy of the preflight documentation form including markings or text representative of marks made on the preflight documentation form, and effecting launching of the helicopter air ambulance. The step of receiving confirmation occurs prior to said step of effecting launching of the helicopter air ambulance.

In a feature of this aspect, the step of receiving a confirmation comprises receiving an electronic copy of the preflight documentation form including markings or text representative of marks made on the preflight documentation form.

In a feature of this aspect, the step of receiving a confirmation comprises receiving a verbal confirmation from an operations control specialist of the receipt of an electronic copy of the preflight documentation form including markings or text representative of marks made on the preflight documentation form.

In a feature of this aspect, the method further includes steps of displaying, to a display for viewing by the pilot, an electronic copy of the preflight documentation form including markings or text representative of marks made on the preflight documentation form, and viewing, by the pilot, the displayed electronic copy. In such implementations, the step of viewing the displayed electronic copy preferably occurs prior to said step of effecting launching of the helicopter air ambulance.

One or more aspects of the present invention relate to systems including components configured to implement any of the above noted methods.

One or more aspects of the present invention relate to apparatus utilized in any of the above noted methods.

One or more aspects of the present invention relate to apparatus configured to implement any of the above noted methods.

One or more aspects of the present invention relate to software configured to facilitate any of the above noted methods.

In addition to the aforementioned aspects and features of the present invention, it should be noted that the present invention further encompasses the various possible combinations and subcombinations of such aspects and features. Thus, for example, any aspect may be combined with an aforementioned feature in accordance with the present invention without requiring any other aspect or feature.

### BRIEF DESCRIPTION OF THE DRAWINGS

One or more preferred embodiments of the present invention now will be described in detail with reference to the accompanying drawings, wherein the same elements are referred to with the same reference numerals, and wherein:

FIG. 1 illustrates an exemplary use of digital pen and paper technologies in an helicopter air ambulance context;

FIG. 2 illustrates an exemplary electronic copy of a form;

FIG. 3 illustrates an exemplary electronic copy of another filled out daily flight log form;

FIG. 4 illustrates an exemplary electronic copy of a filled out daily flight log form utilizing checkboxes;

FIG. 5 illustrates a portion of an exemplary review page utilizing static zones; and

FIGS. 6 and 7 illustrate exemplary processes utilizing digital pen and paper technology in a helicopter air ambulance context.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Although largely described herein in the context of preflight documentation for emergency medical services (EMS) operators and EMS helicopters, it will be appreciated that aspects and features described herein may be applicable in other commercial and noncommercial contexts, and with other types of aircraft, including, for example, fixed wing aircraft. Similarly, although described largely in the context of single engine aircraft, it will be appreciated that aspects and features described herein may be applicable in the context of multi-engine aircraft as well. Additionally, although steps will frequently be described herein as being carried out by a pilot, it will be appreciated that such steps could equally be carried out by other personnel. Similarly, although operations control centers and operations control specialists are described herein, it will be appreciated that other facilities and personnel may equivalently be utilized in at least some implementations.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

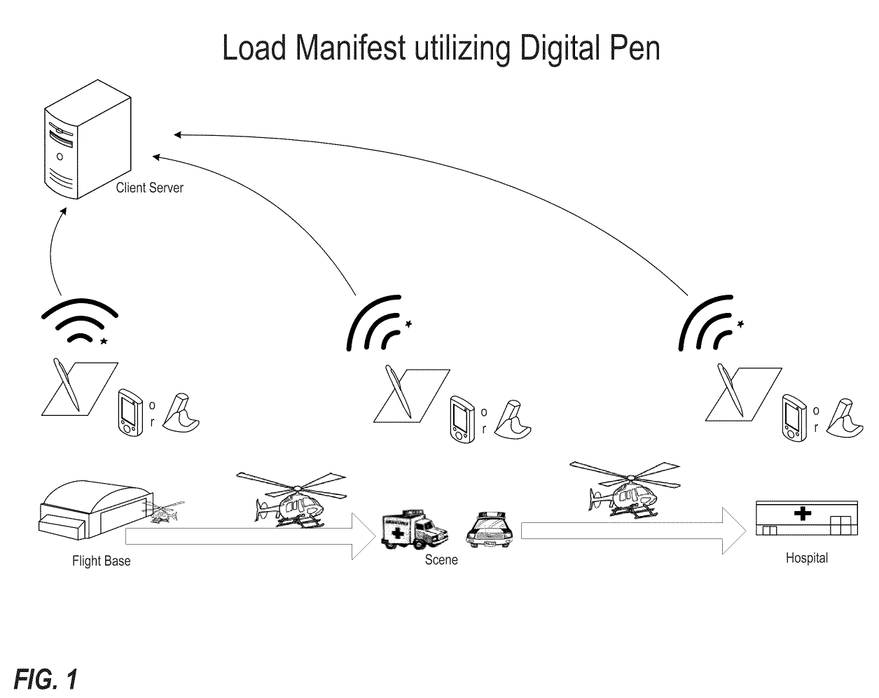

In some preferred systems and methods, digital pen and paper technology is utilized for preparing, and storing, preflight documentation for a helicopter air ambulance. Such preflight documentation might include, for example, a daily flight log (DFL), load manifest, or documents associated with preflight risk analysis. As used herein, “preflight documentation” is intended to mean any, any combination of, or all of these types of documents and can include one or a plurality of forms. FIG. 1 illustrates exemplary use of digital pen and paper technologies in this context. An overview of digital pen and paper technologies that may be utilized in accordance with one or more aspects will first be described, and then exemplary use in a helicopter air ambulance context will be described in more detail.

### Forms

In at least some preferred implementations, a form is created as an electronic document, and then printed onto ordinary paper using specially configured software. A pattern of tiny dots is printed on the paper, thereby effectively allowing the paper to function as “digital paper”. The dots are preferably printed in a carbon black ink which reflects infrared light. A user writes on the digital paper with a specially configured pen. The pen preferably is configured to emit infrared light, which is reflected by the carbon black ink of the dots. The pen includes a tiny sensor which is configured to pick up the infrared light reflected by the tiny dots. Preferably, the pen further includes a processor, memory, and a rechargeable battery. The pen is configured to read the dots using the sensor to store an (x,y) location of a tip of the pen as a user utilizes the pen to make marks on the digital paper.

After the user utilizes the pen to write on the digital paper, the pen uploads information associated with such marks, for example via a dock or via a wireless connection (e.g. Bluetooth), to a display device running software configured to utilize the information to reproduce the marks made by the user. This information then is reproduced in an electronic copy of the form, or in a new document.

### Form Design

In a preferred implementation, a form is designed utilizing software configured to leverage an existing spreadsheet application, such as, for example, Microsoft Excel. For example, such software may utilize Anoto Form Solutions technology from Anoto Group AB of Lund, Sweden.

Preferably such software allows “zones” to be added to a form. Such zones allow a user to group together sections of a form. Preferably, these zones effectively define review and edit areas on a server's preview screen (as described in more detail hereinbelow).

Preferably, such software also allows the addition of a mapping field to an Excel form's fields. Mapping information of this field is then used by a server in the creation of an “output message” to allow straight-through mapping of captured data to import data.

In at least some preferred implementations, form design for customers is limited to simply laying out fields. On the other hand, in at least some implementations, additional form design functionality is provided, particularly for larger or more sophisticated users or entities.

### Form Posting

In a preferred implementation, form posting is implemented utilizing Anoto Form Solutions technology from Anoto Group AB of Lund, Sweden. Such software potentially is configured for SharePoint.

In at least some preferred implementations, a digital pen and paper enabled (“DPP-enabled”) Excel form will be “posted” to a server, e.g. an MT server. The server will then interrogate the form, for example utilizing a combination of MS Excel Object Libraries and an SDK, thereby creating a data structure and dictionaries, (optionally with other associated items, etc.) for later comparison (as described in more detail hereinbelow).

### Form Printing

In at least some preferred implementations, both server side and client side printing are supported.

### Pen Interrogation

In preferred implementations, information is pushed from a pen to a server utilizing one or more methodologies. In a first methodology, information is relayed from a pen to a server via a dock. In at least some preferred implantations, a pen manager for Intel-based Macs is provided.

In a second methodology, information is relayed from a pen to a server via one or more connections, one of which is a wireless connection, such as, for example, a Bluetooth connection. In at least some preferred implementations, a wireless connection with a Blackberry, or other mobile communications device, is supported.

### Server Interrogation

As noted hereinabove, in preferred implementations, a DPP-enabled form is posted to a server, and the server then interrogates the form. A server preferably comprises at least a processor, memory, a storage component, and a communications component configured for wireless, or wired, electronic communications. A server may be comprised of one or more physical machines, which may be located in close proximity to one another or remotely located from one another.

Preferably, hand writing recognition (HWR), for example utilizing optical character recognition (OCR), is implemented into this server interrogation process, and an HWR process is utilized to generate, or interpret, content or data based on information relayed from a digital pen.

In preferred implementations, a graphical representation of markings, or pen strokes, made on a page by a user, which can be characterized as “ink”, is stored along with, and preferably in association with, such generated content or data in one or more databases.

Preferably, such implementations facilitate a much improved loading time of a review screen at a server presentation section.

In preferred implementations, a “Live Query”, or real-time call made to a server or service to retrieve the latest information, can be made at the point of data capture and interpretation. Preferably, this allows the system to request an up to the minute copy of a dictionary to compare against. Such up to the minute dictionary is then preferably applied to fields that are defined as list fields during design. Preferably, the dictionary is updatable through an admin console or via an automated route, e.g. web service.

### Message Creation

In preferred implementations, when a form is processed, an XML message is constructed. This constructed message contains the data entered on the form, as well as associated metadata, e.g. column names, data types, etc. Additional data, such as, for example, a time marks were made on digital paper or a time information conveyed from a pen to a server was interpreted, (one of which may be characterized as an ink time) is preferably also included. Preferably, a PDF of the complete form, zone images and any other graphical data is also included in the message.

In preferred implementations, a control panel allows a user to configure messaging options. Such options preferably include the option to “send to a web service”, “write to a database”, “send via email” or “wait for collection by an external application”. Preferably, there are additional options for notifying the user of activity, e.g. email.

### Exemplary Preflight Documentation Implementations

FIG. 1 illustrates an exemplary use of digital pen and paper technologies in a helicopter air ambulance context. Specifically, FIG. 1 illustrates a helicopter air ambulance that undertakes a first flight from a flight base to an accident scene, and then undertakes a second flight from the accident scene to a hospital. Before the helicopter air ambulance undertakes each leg of its journey, a pilot of the helicopter air ambulance fills out preflight documentation. In preferred implementations, the use of digital pen and paper technology allows markings made by the pilot on such preflight documentation to be captured, and then communicated to one or more remote devices, such as a remote server for storage. In the event of a crash, a copy of the preflight documentation the pilot filled out will be available at the remote server.

Appendix A, which is hereby incorporated herein by reference, illustrates an exemplary preflight documentation form printed using digital pen and paper technology. As described hereinabove, the preflight documentation form preferably includes a pattern of tiny dots printed thereon. The particular pattern of dots printed on a form may be unique to a particular aircraft, company, division, entity, or pilot, etc. A preflight documentation form may be designed, produced, and/or processed utilizing Anoto Form Solutions technology from Anoto Group AB of Lund, Sweden.

In use, a pilot of a helicopter air ambulance fills out a preflight documentation form using a specially configured pen, as described hereinabove. The specially configured pen preferably includes an identification, such as, for example, a unique serial number. The exemplary preflight documentation illustrated in Appendix A has been filled out by a pilot using a specially configured pen, as can be seen in the Appendix.

Thereafter, information associated with the filling out of such preflight documentation form (e.g. information corresponding to marks made on the preflight documentation form) is communicated to a remote server for processing and either storage, or communication to a remote database for storage. In some preferred implementations, the pilot signs the preflight documentation form, and information corresponding to this handwritten signature is communicated as well. In at least some preferred implementations, an identification of the pen is communicated as well. Such communication may include, for example, communication by facsimile, email, online form, or other electronic means.

In some preferred implementations, such communication includes transmitting, via a Bluetooth connection, information to a communication device located proximate the pen. A communication device may comprise, for example, a phone, smartphone, desktop computer, workstation, laptop, tablet, IPad, router, switch, hub, gateway, or other electronic device. Such communication device may utilize, for example, Anoto routing technology available from Anoto Group AB of Lund, Sweden, which provides for configuration of routing capabilities at a Blackberry smartphone. Following receipt at a smartphone or other communication device, information may be forwarded on to a remote server, either directly or indirectly, such as, for example, via email, or via a dedicated data channel.

In some preferred implementations, such communication includes transmitting, via a wireless connection, information to a device disposed at, on, or proximate to the helicopter air ambulance. In at least some preferred implementations, such communication includes communication via the Global System for Mobile Communications (GSM) and/or satellite.

Communicated information associated with the filling out of a preflight documentation form is processed at the remote server. In at least some preferred implementations such processing includes use of optical character recognition (OCR) technology, although in at least some other preferred implementations such processing does not include use of such technology.

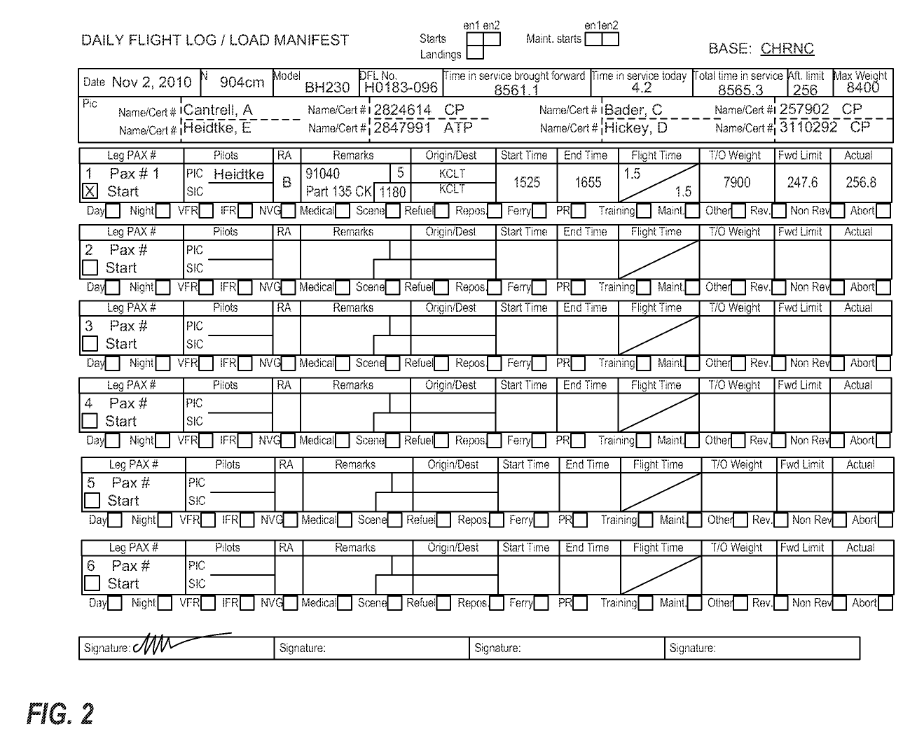

Preferably, such processing includes generation of one or more documents representing an electronic copy of the filled out preflight documentation form. FIG. 2B illustrates an exemplary electronic copy of the form of Appendix A. An electronic copy may utilize typewritten characters resulting from a process utilizing OCR, but in at least some implementations a reproduction, e.g. an image, of handwritten marks, e.g. a signature, may instead be included, as illustrated in FIG. 2. In implementations in which a pilot signed a preflight documentation form, a generated electronic copy of the completed preflight documentation form preferably includes a handwritten signature of the pilot.

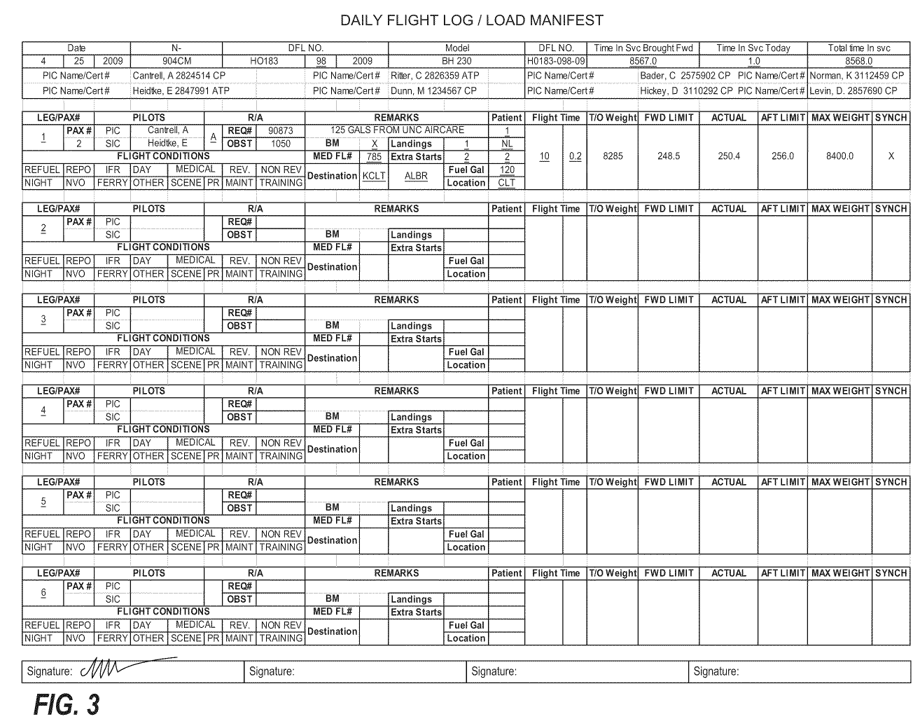

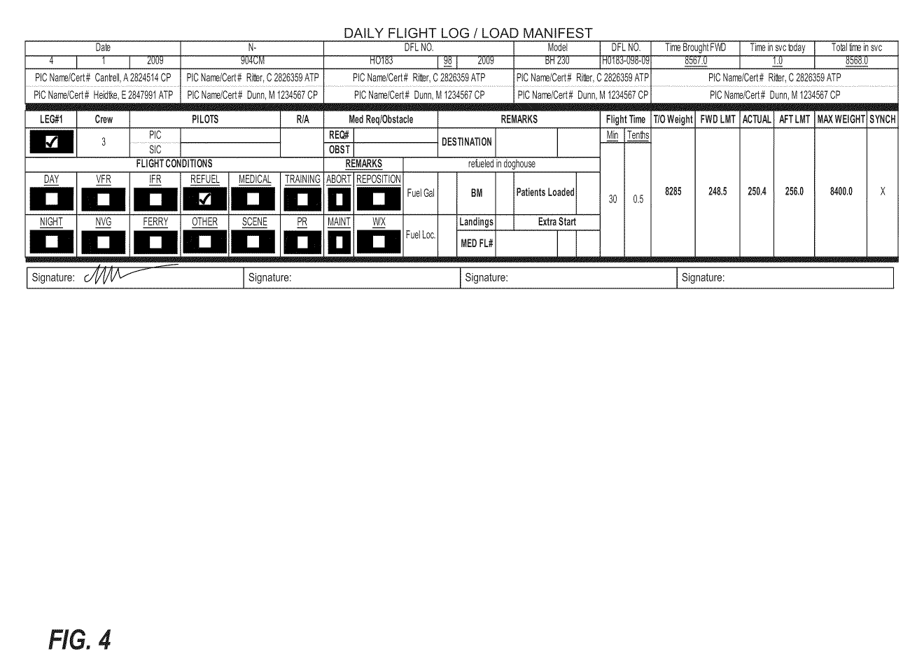

FIGS. 3 and 4 illustrate additional exemplary electronic copies of filled out forms. With respect to the process of character recognition, checkboxes may be utilized to simplify the recognition process. FIG. 4 illustrates a reproduction of an exemplary form utilizing checkboxes to simplify recognition and reproduction.

In at least some preferred implementations, a generated electronic copy is electronically communicated. For example, a generated electronic copy may be emailed to one or more email addresses associated with an account associated with the preflight documentation form, or with the specially configured pen utilized to fill out the preflight documentation form. Each account may be associated with one or more unique patterns of dots of the preflight documentation form as described hereinabove, and/or with one or more specially configured pens.

In some preferred implementations, a confirmation of receipt of information associated with filling out of preflight documentation, or of an electronic copy of preflight documentation, is provided to a pilot prior to takeoff. For example, in one or more preferred implementations, an electronic copy of preflight documentation is mailed to an email address, or communicated to a mobile device, such as a smart phone, associated with a pilot who filled out the preflight documentation. Generally, in some preferred implementations, an electronic copy is communicated to a display device for display. A display device may comprise, for example, a phone, smartphone, desktop computer, workstation, laptop, tablet, IPad, or other electronic device having a display screen.

In at least some such preferred implementations, the pilot may leave the physical copy of preflight documentation that was filled out at a takeoff location, and keep an electronic copy of the preflight documentation on board with him, or vice versa. In at least some implementations, an electronic copy may be stored both on the plane and at the takeoff location.

In at least some preferred implementations, a remote server is located at or proximate to an operations base or operations control center, and/or is configured to communicate an electronic copy of a preflight documentation form to an operations control specialist.

In some implementations, an operations control specialist is in two way radio communications with the pilot, and, upon receipt of preflight documentation, confirms receipt of the preflight documentation to the pilot. The operations control specialist confirms receipt by reading back, to the pilot, some or all information from the preflight documentation.

In at least some implementations, an operations control specialist receives an electronic copy of a preflight risk analysis worksheet form filled out by a pilot, and confirms and verifies the entries on the worksheet form, and works with the pilot to mitigate any identified risk.

In at least some preferred implementations, an operations control specialist additionally has a specially configured pen, and uses such specially configured pen during participation in preflight risk analysis.

Operations control specialists preferably perform safety sensitive functions such as, for example, providing preflight weather assessments; assisting with fuel planning; assisting with risk analysis; providing supplementary information regarding weather, route information, and landing zones; communicating with pilots regarding operational concerns during flight; and monitoring flight progression.

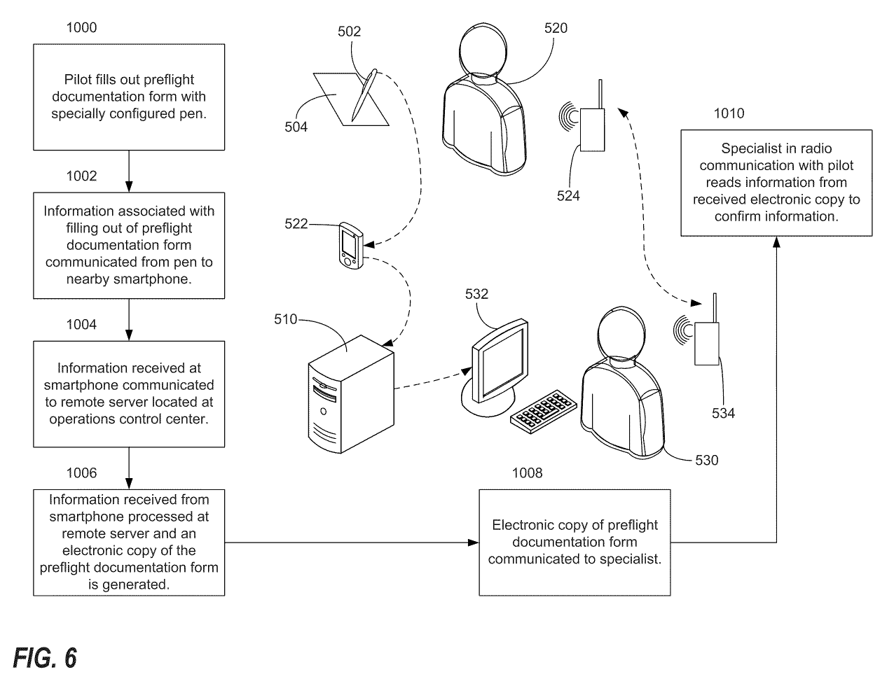

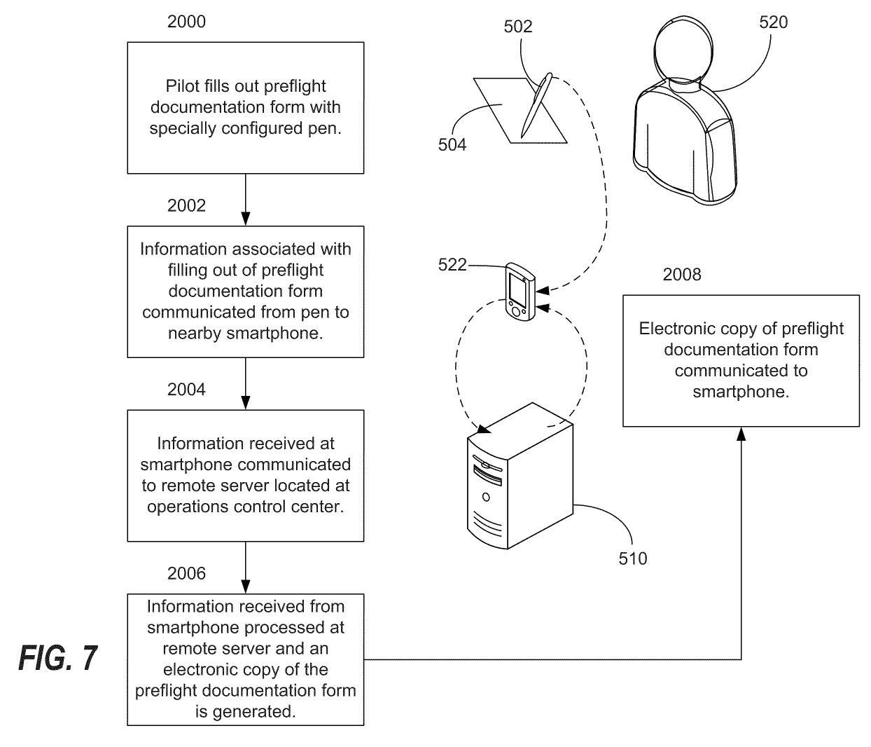

Two exemplary processes utilizing digital pen and paper technology in a helicopter air ambulance context will now be described with reference to FIGS. 6 and 7.

In a first of these processes, at step 1000, a helicopter air ambulance pilot 520, with or without the assistance of an operations control specialist 530, conducts a preflight risk assessment before the first leg of a helicopter air ambulance operation, and completes, signs, and dates a completed risk analysis worksheet form 504 with a specially configured pen 502. Information related to this process is then communicated by the specially configured pen 502 to a remote server 510, either directly (not illustrated) or indirectly via one or more communication devices. In the process illustrated in FIG. 6, the information is communicated to a smartphone 522 at step 1002 and then to the remote server 510 at step 1004. At step 1006, the remote server generates an electronic copy of the form 504. This electronic copy is then provided to an operations control specialist 530 at step 1008, who confirms and verifies the entries on the form 504. At step 1010, the operations control specialist 530, who is in radio communication with the pilot 520 via radios 524, 534, reads information from the received electronic copy to confirm its accuracy with the pilot, which also serves to confirm receipt prior to launch. In at least some implementations, an electronic copy of the form 504 is preferably then retained in a secure location for at least ninety days.

In a similar process, at step 2000, the helicopter air ambulance pilot 520, with or without the assistance of an operations control specialist, conducts a preflight risk assessment before the first leg of a helicopter air ambulance operation, and completes, signs, and dates a completed risk analysis worksheet form 504 with the specially configured pen 502. Information related to this process is then communicated by the specially configured pen 502 to a remote server 510, either directly (not illustrated) or indirectly via one or more communication devices. In the process illustrated in FIG. 7, the information is communicated to a smartphone 522 at step 2002 and then to the remote server 510 at step 2004. At step 2006, the remote server generates an electronic copy of the form 504. This electronic copy is then communicated to the smartphone 522, for example for confirmation of receipt of a copy of form 504 prior to launch.

In one or more preferred implementations, one or more remote servers are configured to process information associated with forms utilized by multiple entities or organizations. Preferably, an identification of a pen, and/or an identification derived from a pattern of dots of a form, is associated with a service, entity, or user in a database.

In at least some preferred implementations, a pen is associated with a single pilot, and a remote server may look up the identity of a pilot associated with a pen and provide this information to an operations control specialist for confirmation. In at least some preferred implementations, this provides two authentication mechanisms, as an operations control specialist can confirm both that a form was filled out using a certain pilot's pen, and that the pilot's signature is on the form.

In at least some preferred implementations, a remote server is configured such that it determines whether the pen used to fill out a particular form was a certain pen specified by security settings. For example, in a preferred scenario, a remote server may be configured to determine whether a form was filled out using a certain pilot's pen, and may also determine whether a signature on the form belongs to that certain pilot.

### Server Presentation

At least some preferred implementations include a browser independent review/edit/approval page. In at least some implementations, such page comprises a SilverLight control. In at least one implementation, such page builds on, extends, or leverages a SilverLight control. Preferably, however, the page is configured for browser independence, loading of pre-saved “ink” images, and form layout alteration.

In a preferred implementation, a screen displayed to a user is split into sections, as is a form. Each section includes either an image of an original copy of a form including handwriting thereon, or a graphical representation of the form overlaid with data interpreted from the handwritten original copy.

A user's prior definition of “zones” at form creation determines how many sections are displayed, as well as the order of display.

Preferably, a zone can be defined as static. Such a static zone is preferably permanently “docked” on the screen. It will be appreciated that docking can be characterized as a method of locking an object to a specific section of a presentation area, such as, for example, to the left, right, top or bottom of a presentation area.

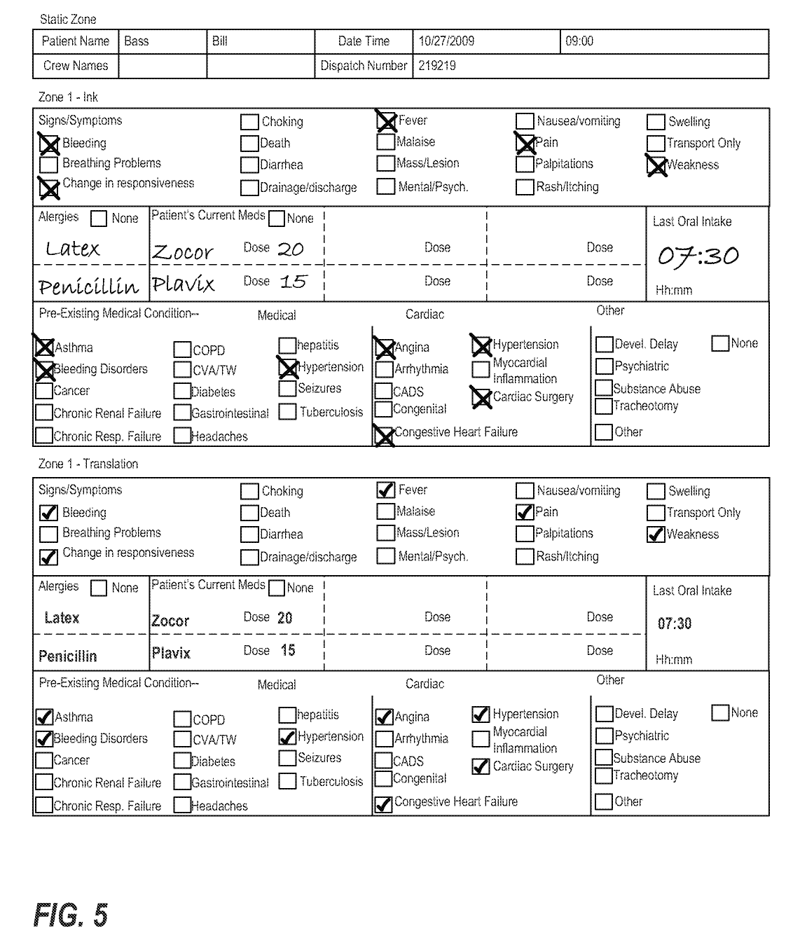

Thus, the definition of static zones allows for a section of a form to be permanently docked on the screen. It is believed that this facilitates an extremely fast user review experience. Preferably, both the “ink” and interpreted/translated data are presented side by side or above and below, thus facilitating a visual comparison, as illustrated in FIG. 5. Preferably, it is possible to directly edit on the interpreted section of the screen.

The page allows a user to approve a zone. Once a zone is approved, another zone is displayed for approval. This process continues until the form has been processed in full. Preferably, next and previous interface elements allow a user to navigate between zones. Upon approval of all zones, the form is approved. Preferably, user configurable preferences will determine whether a next form is processed, a user is prompted to pick another available form, or the review/approval process is terminated.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

What is claimed is:

1. A method for facilitating remote storage of preflight documentation for a helicopter air ambulance, the method comprising:
(a) transmitting, by a pen, data to a communication device configured for forwarding of the data to a remote server, the data comprising,
(i) information associated with marks made on a preflight documentation form with the pen, and
(ii) an identification of the pen,
(iii) wherein,
(A) the pen is configured to electronically record information associated with marks made with the pen on the preflight documentation form, and
(B) marks made on the preflight documentation form include a handwritten signature of a pilot;
(b) receiving, at the communication device, the transmitted data comprising information associated with marks made with the pen on the preflight documentation form and the identification of the pen;
(c) communicating, from the communication device to a remote server, the data comprising information associated with marks made with the pen on the preflight documentation form and the identification of the pen received at the communication device;
(d) receiving, at the remote server, the communicated data comprising information associated with marks made with the pen on the preflight documentation form and the identification of the pen; and
(e) processing, at the remote server, the information associated with marks made with the pen on the preflight documentation form, said processing including generating an electronic copy of the preflight documentation form representative of the preflight documentation form, including the handwritten signature of the pilot;
(f) wherein said step of receiving, at the remote server, the communicated data comprising information associated with marks made on the preflight documentation form and the identification of the pen occurs prior to launching of the helicopter air ambulance.

2. The method of claim 1, wherein the method further comprises the step of providing an acknowledgment, to the pilot, that an electronic copy of the preflight documentation form has been generated and is being stored remotely.

3. The method of claim 1, wherein the method further comprises the steps of providing an electronic copy of the preflight documentation form to an operations control specialist who is responsible for verbally confirming, via two way radio communications with the pilot, receipt of an electronic copy of the preflight documentation form.

4. The method of claim 1, wherein the marks made on the preflight documentation form are ink marks and wherein the preflight documentation form is a paper form.

5. The method of claim 4, wherein the communication device comprises a mobile consumer electronic device.

6. The method of claim 1, wherein said step of communicating, from the communication device to a remote server, the data comprising information associated with marks made on the preflight documentation form and the identification of the pen received at the communication device comprises communicating via email.

7. The method of claim 1, wherein said step of communicating, from the communication device to a remote server, the data comprising information associated with marks made on the preflight documentation form and identification of the pen received at the communication device comprises communicating via satellite.

8. The method of claim 1, wherein said step of communicating, from the communication device to a remote server, the data comprising information associated with marks made on the preflight documentation form and identification of the pen received at the communication device comprises communicating via GSM.

9. The method of claim 1, wherein said step of transmitting data comprising information associated with marks made on the preflight documentation form, and an identification of the pen, to a communication device configured for forwarding the data to a remote server comprises transmitting via a Bluetooth connection.

10. The method of claim 1, wherein the communication device is disposed inside of, attached to, or is part of the helicopter air ambulance.

11. The method of claim 1, wherein the preflight documentation form includes a plurality of tiny dots printed thereon, and wherein said step of processing, at the remote server, the information associated with marks made with the pen on the preflight documentation form includes determining an entity associated with the preflight documentation form based on a pattern of the plurality of tiny dots of the preflight documentation form.

12. A method for facilitating remote storage of preflight documentation for a helicopter air ambulance, the method comprising:
(a) transmitting, by a pen, data to a communication device configured for forwarding of the data to a remote server, the data comprising,
(i) information associated with marks made on a preflight documentation form with the pen, and
(ii) an identification of the pen,
(iii) wherein the pen is configured to electronically record information associated with marks made on the preflight documentation form;
(b) receiving, at the communication device, the transmitted data comprising information associated with marks made on the preflight documentation form and the identification of the pen;
(c) communicating, from the communication device to a remote server, the data comprising information associated with marks made on the preflight documentation form and the identification of the pen received at the communication device;
(d) receiving, at the remote server, the communicated data comprising information associated with marks made on the preflight documentation form and the identification of the pen;
(e) processing, at the remote server, the information associated with marks made on the preflight documentation form, said processing including generating an electronic copy of the preflight documentation form including markings or text representative of marks made on the preflight documentation form;
(f) receiving, at an electronic device, a confirmation of receipt of the data comprising information associated with marks made on the preflight documentation form and the identification of the pen, the confirmation including an electronic copy of the preflight documentation form including markings or text representative of marks made on the preflight documentation form; and
(g) displaying, on a display of the electronic device, the electronic copy of the preflight documentation form including markings or text representative of marks made on the preflight documentation form;
(h) wherein said step of displaying, on a display of the electronic device, the electronic copy of the preflight documentation form occurs prior to launching of the helicopter air ambulance.

13. The method of claim 12, wherein the electronic device and the communication device are the same device.

14. The method of claim 12, wherein the communication device comprises a mobile device.

15. The method of claim 12, wherein the communication device is disposed inside of, attached to, or is part of the helicopter aft ambulance.

16. The method of claim 12, wherein the electronic device is disposed proximate an operations control specialist and is configured to display the electronic copy for viewing by the operations control specialist.

17. A method for facilitating remote storage of preflight documentation for a helicopter air ambulance, the method comprising:
(a) filling out, by a pilot of the helicopter air ambulance, a preflight documentation form with a specially configured pen, the filling out including hand signing, with the specially configured pen, the preflight documentation form, wherein,
(i) the preflight documentation form includes a plurality of tiny dots printed thereon, and
(ii) the specially configured pen is configured to electronically record information associated with marks made on the preflight documentation form;
(b) effecting transmission, from the specially configured pen, of data to a communication device configured for forwarding of the data to a remote server, the data comprising,
(i) information associated with marks made on the preflight documentation form, and
(ii) an identification of the specially configured pen,
(iii) wherein
(A) the preflight documentation form includes a plurality of tiny dots printed thereon,
(B) the specially configured pen is configured to electronically record information associated with marks made on the preflight documentation form, and
(C) marks made on the preflight documentation form include a handwritten signature of the pilot;
(c) receiving, by the pilot, a confirmation of remote storage of an electronic copy of the preflight documentation form including markings or text representative of marks made on the preflight documentation form; and
(d) effecting launching of the helicopter air ambulance;
(e) wherein said step of receiving confirmation occurs prior to said step of effecting launching of the helicopter air ambulance.

18. The method of claim 17, wherein said step of receiving a confirmation comprises receiving an electronic copy of the preflight documentation form including markings or text representative of marks made on the preflight documentation form.

19. The method of claim 17, wherein said step of receiving a confirmation comprises receiving a verbal confirmation from an operations control specialist of the receipt of an electronic copy of the preflight documentation form including markings or text representative of marks made on the preflight documentation form.

20. The method of claim 17, wherein the method further includes steps of
(a) displaying, to a display for viewing by the pilot, an electronic copy of the preflight documentation form including markings or text representative of marks made on the preflight documentation form; and
(b) viewing, by the pilot, the displayed electronic copy;
(c) wherein said step of viewing the displayed electronic copy occurs prior to said step of effecting launching of the helicopter air ambulance.
